(19) United States
(12) Patent Application Publication
(10) Pub. No.: US 2018/0267897 A1
(43) Pub. Date: Sep. 20, 2018

(54) MEMORY SYSTEM AND OPERATING METHOD THEREOF

(71) Applicant: SK hynix Inc., Gyeonggi-do (KR)

(72) Inventor: Beom-Rae JEONG, Gyeonggi-do (KR)

(21) Appl. No.: 15/726,489

(22) Filed: Oct. 6, 2017

(30) Foreign Application Priority Data
Mar. 14, 2017 (KR) 10-2017-0031599

(51) Int. Cl. G06F 12/0802

(52) U.S. Cl. CPC G06F 12/0802; G06F 2212/608; G06F 2212/1024

(57) ABSTRACT

A memory system includes: a memory device; and a controller including a cache which is coupled between a host and the memory device and includes a plurality of storing regions, for determining whether or not a storing region corresponding to address information which is requested by the host exists in the cache among the plurality of the storing regions based on bitmap information which hierarchically represents the plurality of the storing regions.

### CROSS-REFERENCE TO RELATED APPLICATIONS

The present application claims priority to Korean Patent Application No. 10-2017-0031599, filed on Mar. 14, 2017, which is herein incorporated by reference in its entirety.

### BACKGROUND

### 1. Field

Various embodiments of the present disclosure relate to a memory system and an operating method thereof.

### 2. Description of the Related Art

Recently, the paradigm of the computer environment has changed into a ubiquitous computing environment which allows users to access a computer system anywhere and at any time. For this reason, the use of portable electronic devices, such as mobile phones, digital cameras, laptop computers and the like, is surging. The portable electronic devices generally employ a memory system using a memory device for storing data. A memory system may be used as a main memory device or an auxiliary memory device of a portable electronic device.

A memory device has excellent stability and durability since it does not include a mechanical driving unit. Also, the memory device is advantageous in that it may access data quickly and consume a small amount of power. Non-limiting examples of a memory device having these advantages include an universal serial bus (USB) memory device, a memory card with diverse interfaces, and a solid-state drive (SSD).

### SUMMARY

Embodiments of the present disclosure are directed to a memory controller for a quick cache search, a memory system, and a method for operating the memory system.

In accordance with an embodiment of the present invention, a memory system may include: a memory device; and a controller including a cache which is coupled between a host and the memory device and includes a plurality of storing regions, for determining whether or not a storing region corresponding to address information which is requested by the host exists in the cache among the plurality of the storing regions based on bitmap information which hierarchically represents the plurality of the storing regions.

The controller may divide the plurality of the storing regions into a plurality of ranges each of the plurality of ranges including at least two storing regions, and generate the bitmap information which hierarchically represents the plurality of the ranges and the plurality of the storing regions.

The bitmap information may include 1-level bits and 2-level bits, and the 1-level bits may respectively correspond to the plurality of the ranges, and the 2-level bits may respectively correspond to storing regions that are included in each of the plurality of the ranges.

The controller may update the bitmap information in response to a write request or a read request from the host.

When the controller determines that a storing region corresponding to address information according to the write request does not exist in the cache, the controller may cache the data in the cache and set a value of a corresponding bit of the bitmap information based on the cached result.

When the data is flushed from the cache to the memory device, the controller may clear the value of the corresponding bit of the bitmap information.

When the controller determines that a storing region corresponding to address information according to the read request exists in the cache, the controller may read a data according to the read request which is stored in the cache and transfers the data to the host.

In accordance with another embodiment of the present invention, a memory controller may include: a cache coupled between a host and a memory device, including a plurality of storing regions; and a processor suitable for determining whether or not a storing region corresponding to address information which is requested by the host exists in the cache among the plurality of the storing regions based on bitmap information which hierarchically represents the plurality of the storing regions.

The processor may divide the plurality of the storing regions into a plurality of ranges each of the plurality of ranges including at least two storing regions, and generate the bitmap information which hierarchically represents the plurality of the ranges and the plurality of the storing regions.

The bitmap information may include 1-level bits and 2-level bits, and the 1-level bits may respectively correspond to the plurality of the ranges, and the 2-level bits may respectively correspond to storing regions that are included in each of the plurality of the ranges.

The processor may update the bitmap information in response to a write request or a read request from the host.

When the processor determines that a storing region corresponding to address information according to the write request does not exist in the cache, the processor may cache the data in the cache and set a value of a corresponding bit of the bitmap information based on the cached result.

When the data is flushed from the cache to the memory device, the processor may clear the value of the corresponding bit of the bitmap information.

When the processor determines that a storing region corresponding to address information according to the read request exists in the cache, the processor may read a data according to the read request which is stored in the cache and transfer the data to the host.

In accordance with another embodiment of the present invention, a method for operating a memory controller including a cache that is coupled between a host and a memory device and includes a plurality of storing regions may include: receiving a request from the host; and determining whether or not a storing region corresponding to address information which is included in the request exists in the cache among the plurality of the storing regions based on bitmap information which hierarchically represents the plurality of the storing regions.

The method may further include: dividing the plurality of the storing regions into a plurality of ranges, each of the plurality of ranges including at least two storing regions; and generating the bitmap information which hierarchically represents the plurality of the ranges and the plurality of the storing regions.

The bitmap information may include 1-level bits and 2-level bits, and the 1-level bits may respectively correspond to the plurality of the ranges, and the 2-level bits may respectively correspond to storing regions that are included in each of the plurality of the ranges.

The method may further include: updating the bitmap information in response to a write request or a read request from the host.

The updating of the bitmap information may include: when a storing region corresponding to address information according to the write request does not exist in the cache, caching the data in the cache and setting a value of a corresponding bit of the bitmap information based on the cached result.

The updating of the bitmap information may further include: when a storing region corresponding to address information according to the read request exists in the cache, reading a data according to the read request which is stored in the cache and transferring the data to the host.

### BRIEF DESCRIPTION OF THE DRAWINGS

The above and other features and advantages of the present invention will become more apparent to those skilled in the art to which the present invention pertains by the following detailed description with reference to the attached drawings in which:

FIG. 1 is a block diagram illustrating a data processing system including a memory system in accordance with an embodiment of the present disclosure;

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2;

FIG. 4 is a schematic diagram illustrating an exemplary three-dimensional structure of the memory device shown in FIG. 2;

FIG. 5 is a block diagram illustrating a data processing system including a memory system in accordance with an embodiment of the present disclosure;

FIG. 6 illustrates an example of dividing a plurality of storing regions in accordance with an embodiment of the present disclosure;

FIG. 7A illustrates an example of a bitmap structure for a cache search in accordance with an embodiment of the present disclosure;

FIG. 7B illustrates another example of a bitmap structure for a cache search in accordance with an embodiment of the present disclosure;

FIG. 8 is a flowchart illustrating an operation of a controller in accordance with an embodiment of the present disclosure;

FIG. 9 is a flowchart illustrating an operation of a controller in accordance with an embodiment of the present disclosure; and

FIGS. 10 to 18 are diagrams schematically illustrating application examples of the data processing system shown in FIG. 1 in accordance with various embodiments of the present disclosure.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, the various embodiments of the present invention will be described in detail with reference to the attached drawings.

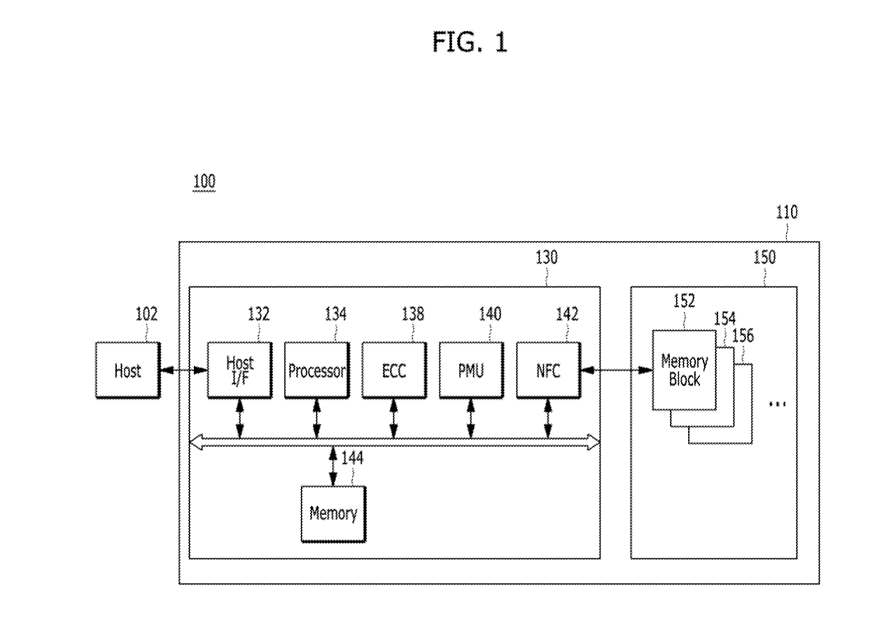

FIG. 1 is a block diagram illustrating a data processing system 100 including a memory system 110 in accordance with an embodiment of the present disclosure.

Referring to FIG. 1, the data processing system 100 may include a host 102 operatively coupled to the memory system 110.

The host 102 may be any suitable electronic device including portable electronic devices such as a mobile phone, MP3 player and laptop computer or non-portable electronic devices such as a desktop computer, game machine, television (TV) and projector. The host 102 may include at least one operating system (OS), and the OS may manage and control the overall functions and operations of the host 102, and also provide an operation between the host 102 and a user using the data processing system 100 or the memory system 110. The OS may support functions and operations corresponding to the use, purpose and usage of a user. For example, the OS may be divided into a general OS and a mobile OS, depending on the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. The host 102 may include one or more of OSs. The host 102 may execute an OS to perform an operation corresponding to a user's request on the memory system 110.

The memory system 110 may operate by storing data for the host 102 in response to a request of the host 102. Non-limited examples of the memory system 110 may include a solid state drive (SSD), a multi-media card (MMC), a secure digital (SD) card, universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may be embodied by various types of storage devices. Non-limited examples of storage devices included in the memory system 110 may include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The flash memory may have a 3-dimensional (3D) stack structure.

The memory system 110 may include a memory device 150 and a controller 130. The memory device 150 may store data for the host 120, and the controller 130 may control data storage into the memory device 150.

The controller 130 and the memory device 150 may be integrated into a single semiconductor device, which may be included in the various types of memory systems as exemplified above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies (not shown), each memory die including a plurality of planes (not shown), each plane including a plurality of memory blocks 152 to 156, each of the memory blocks 152 to 156 may include a plurality of pages (not illustrated), and each of the pages may include a plurality of memory cells coupled to a word line (not illustrated).

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a processor 134, an error correction code (ECC) unit 138, a Power Management Unit (PMU) 140, a NAND flash controller (NFC) 142 and a memory 144 all operatively coupled via an internal bus.

The host interface unit 132 may be configured to process a command and data of the host 102, and may communicate with the host 102 through one or more of various interface protocols such as universal serial bus (USB), multi-media card (MMC), peripheral component interconnect-express (PCI-e), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may provide and manage power of the controller 130.

The NFC 142 may serve as a memory/storage interface for interfacing the controller 130 and the memory device 150 when the memory device is a NAND flash memory, such that the controller 130 controls the memory device 150 in response to a request from the host 102. When the memory device 150 is a flash memory or specifically a NAND flash memory, the NFC 142 may generate a control signal for the memory device 150 and process data to be provided to the memory device 150 under the control of the processor 134. The NFC 142 may work as an interface for example, a NAND flash interface for processing a command and data between the controller 130 and the memory device 150. Specifically, the NFC 142 may support data transfer between the controller 130 and the memory device 150. Other memory/storage interfaces may be used when a different type memory device is employed.

The memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, and may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

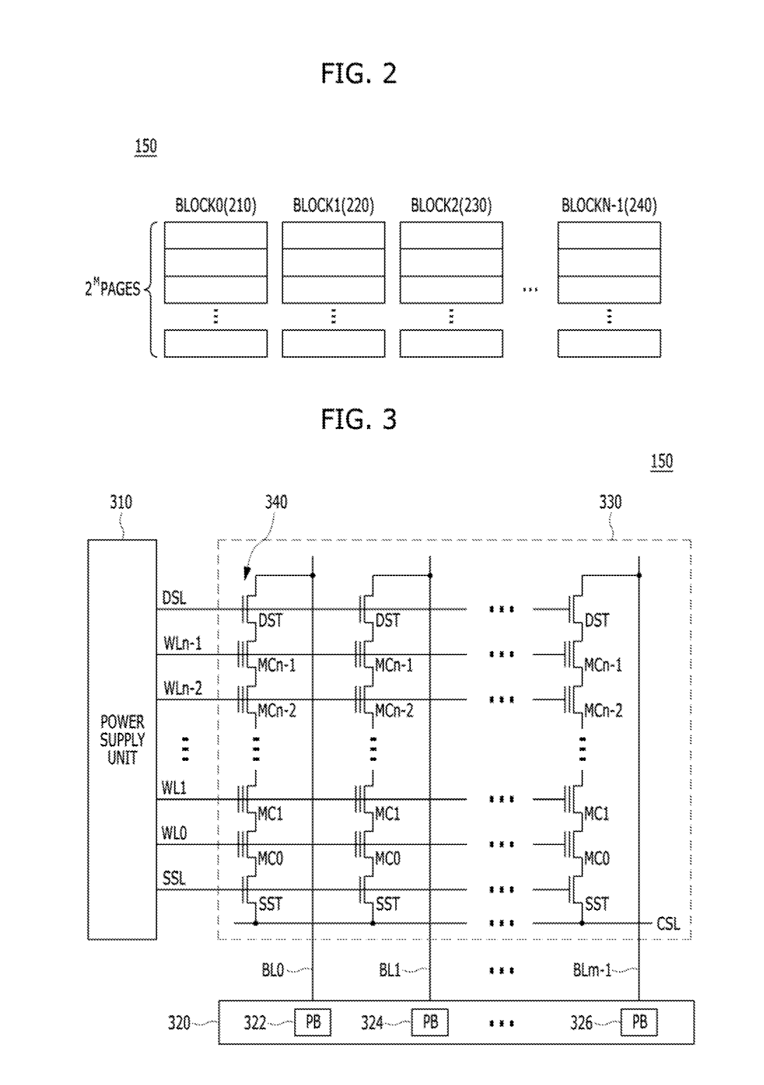

FIG. 2 is a schematic diagram illustrating an exemplary configuration of the memory device 150 employed in the memory system 110 shown in FIG. 1.

Referring to FIG. 2, the memory device 150 may include a plurality of memory blocks 0 to N−1, and each of the blocks 0 to N−1 may include a plurality of pages, for example, 2^{M} pages, the number of which may vary according to circuit design. Memory cells included in the respective memory blocks 0 to N−1 may be one or more of a single level cell (SLC) storing 1-bit data, a multi-level cell (MLC) storing 2-bit data, an MLC storing 3-bit data also referred to as a triple level cell (TLC), an MLC storing 4-bit data also referred to as a quadruple level cell (QLC), or an MLC storing 5-bit or more bit data.

FIG. 3 is a circuit diagram illustrating an exemplary configuration of a memory cell array of a memory block in the memory device 150 shown in FIG. 2.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the invention is not limited in this way. For example, it is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks or sectors of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns or bit lines, or column pairs or bit line pairs, and each of the page buffers 322 to 326 may include a plurality of latches (not illustrated).

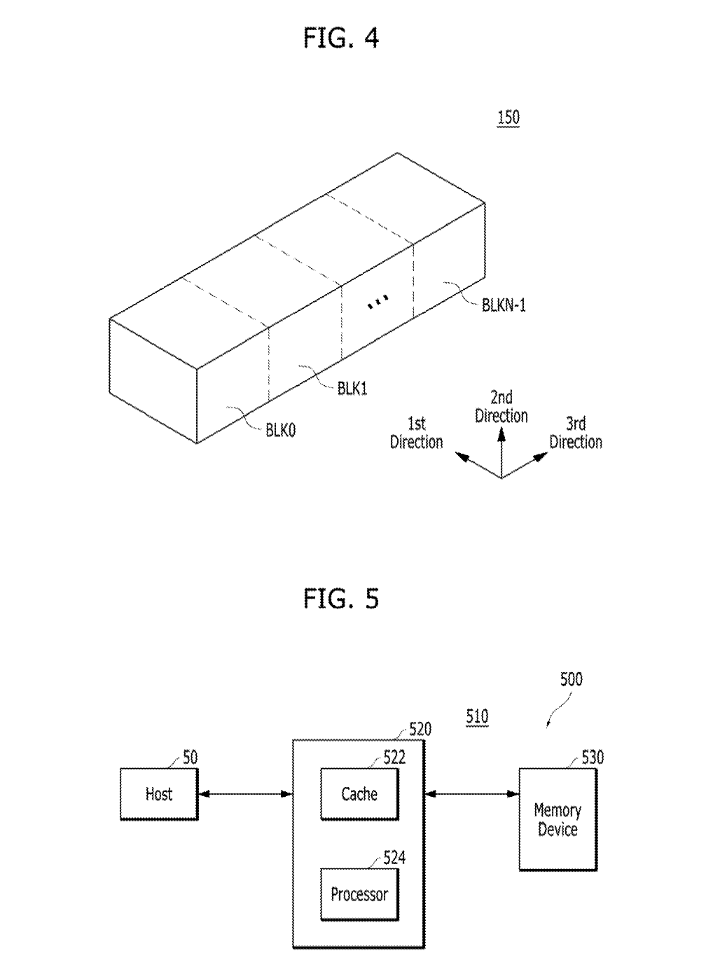

FIG. 4 is a schematic diagram illustrating an exemplary three-dimensional (3D) structure of the memory device 150 shown in FIG. 2.

The memory device 150 may be embodied by a two-dimensional (2D) or three-dimensional (3D) memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure or vertical structure.

As described above, a memory controller may store data that are required to perform a data write operation and a data read operation between a host and a memory device, and data for data write operation and a data read operation in a buffer or a cache, which is to be collectively referred to as a cache, hereafter. When a write request or a read request is received from the host, the memory controller may search a cache to find out whether there is a data that is accessed recently. If there are many data stored in the cache, a cache search time may become long. Also, write or read latency may become irregular according to the amount of data stored in a cache.

For example, when a read cache is used, the cache search time for a read operation may become longer as the amount of data stored in the cache is greater, although a cache hit does not occur, and the longer cache search time may affect the read latency. To take another example, when a write cache is used, it may be advantageous to collect as many data as possible and write the collected data in a memory device, for example, a NAND memory device. However, the cache search time for a write operation may become long. Even though a cache hit does not occur, the write cache search time may substantially affect the read latency.

Therefore, the following embodiments of the present invention provide a method for rapidly searching a cache. According to the method for searching a cache rapidly, the cache search time may be reduced and read or write latency may be secured at a uniform level by using a hierarchical bitmap structure and searching the cache based on the logical ranges instead of the logical addresses.

FIG. 5 is a block diagram illustrating a data processing system 500 including a memory system 510 in accordance with an embodiment of the present disclosure.

Referring to FIG. 5, the data processing system 500 may include a host 50 and a memory system 510. The memory system 510 may include a controller 520 and a memory device 530. The host 50 and the memory system 510 may be constituent elements that respectively correspond to the host 102 and the memory device 110 illustrated in FIG. 1. The controller 520 and the memory device 530 may be constituent elements that respectively correspond to the controller 130 and the memory device 150 illustrated in FIG. 1. The description on the constituent elements illustrated in FIG. 5 are not restrictive but illustrative only.

The controller 520 may control the memory device 530 in response to a request from the host 50. For example, the controller 520 may provide the host 50 with data that is read from the memory device 530, and store the data for a write operation that is supplied from the host 50 in the memory device 530. The controller 520 may include a cache 522 and a processor 524. The cache 522 and the processor 524 may be constituent elements that respectively correspond to the memory 144 and the processor 134 illustrated in FIG. 1.

The processor 524 may control the general operation of the memory system 510. The processor 524 may drive a firmware which is called a flash translation layer (FTL) to control the general operation of the memory system 510.

The processor 524 may perform an operation corresponding to a command or a request that is received from the host 50 along with the memory device 530. For example, the processor 524 may control a write operation for the memory device 530 in response to a write request from the host 50. For another example, the processor 524 may control a read operation for the memory device 530 in response to a read request from the host 50. In particular, the processor 524 may perform a cache search operation, which is described below.

The cache 522 may be an operation memory of the controller 520 that is coupled between the host 50 and the memory device 530, and stores data related to the operation of the controller 520. For example, when the controller 130 performs an operation, such as a read operation, a write operation, or an erase operation, for the memory device 150 in response to a request from the host 102, the cache 522 may store related user data and/or map data. Herein, the map data may be information representing a storing region for example, a page of the memory device 530 where the user data is stored. The cache 522 may also be called a program memory, a data memory, a write buffer/cache, a read buffer/cache, a data buffer/cache, or a map buffer/cache. The cache 522 may be formed of a volatile memory, such as a static random access memory (SRAM) or a dynamic random access memory (DRAM). As illustrated, the cache 522 may be included in the inside of the controller 520. However, differently from the drawing, it is also possible to dispose the cache 522 in the outside of the controller 520.

When a write request is received from the host 50, the processor 524 may store or cache user data corresponding to the received write request in the cache 522 and then transfer the stored user data to the memory device 530 and store the user data in the memory device 530. The stored user data may be transferred to the memory device 530 using a cache copy or cache flush. Also, the processor 524 may generate map data related to the write operation of the user data and store the map data in the cache 522.

When a read request is received from the host 50, the processor 524 may read a user data corresponding to the received read request from the cache 522 or the memory device 530 and transfer the read user data to the host 50. If the user data corresponding to the received read request is stored in the cache 522, the processor 524 may transfer the stored user data to the host 50. Otherwise, if the user data corresponding to the received read request is not stored in the cache 522, the processor 524 may read the user data from the memory device 530, store the read user data in the cache 522, and then transfer the stored user data to the host 50.

In various embodiments, when a write request or a read request is received from the host 50, the controller 520 may search the cache 522 to decide whether there is data corresponding to the received request in the cache 522. The controller 520 may be able to search the cache 522 based on bitmap information which hierarchically represent a plurality of storing regions that are included in the memory device 530. In short, the processor 524 may search the cache 522 and decide whether there is a storing region corresponding to address information for example, a logical block address LBA which is requested by the host 50 among a plurality of storing regions in the memory device 530. Herein, when there is a storing region corresponding to the address information, it may mean that the data corresponding to the address information is stored in the cache 522.

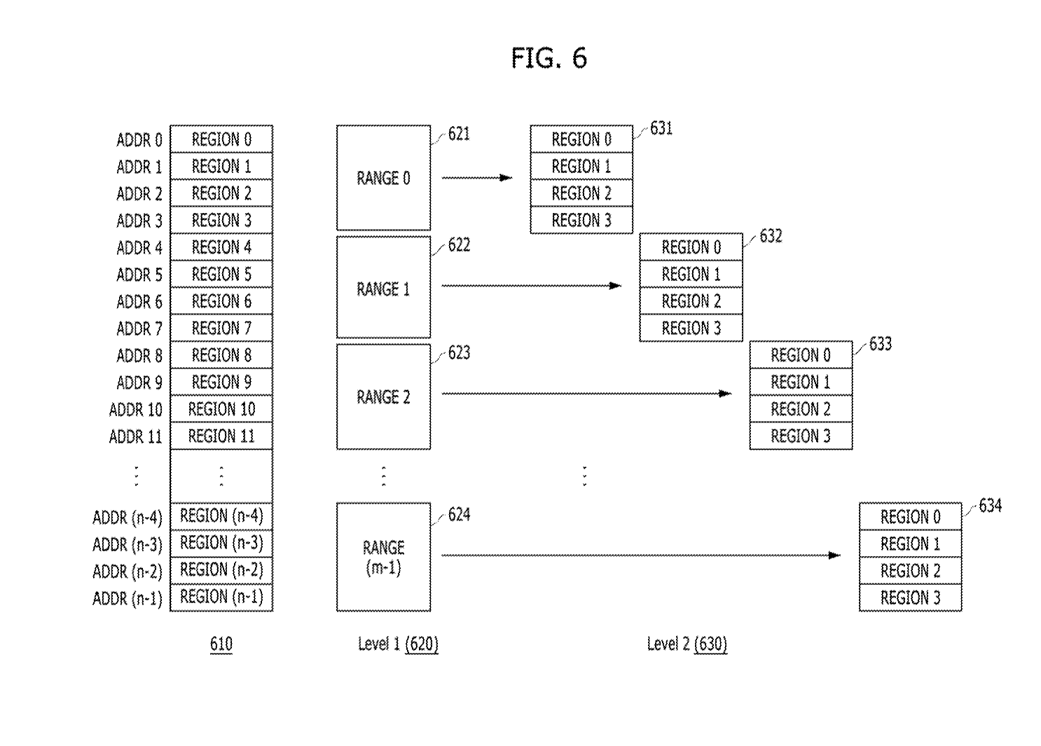

FIG. 6 illustrates an example of dividing a plurality of storing regions 610 in accordance with an embodiment of the present disclosure. For example, the storing regions 610 illustrated in FIG. 6 may be the storing regions that are included in the cache 522 shown in FIG. 5.

Referring to FIG. 6, the storing regions 610 may include n regions, and addresses may be set to correspond to the n storing regions 610, respectively. For example, an address 0 may be set for a region 0. An address 1 may be set for a region 1. An address 2 may be set for a region 2. An address 3 may be set for a region 3. An address (n−4) may be set for a region (n−4). An address (n−3) may be set for a region (n−3). An address (n−2) may be set for a region (n−2). An address (n−1) may be set for a region (n−1). In various embodiments, each of the storing regions may be set as a page corresponding to a logical block address LBA which is requested by the host 50 or a physical block address PBA which indicates a memory region included in the memory device 530, or a memory region of an appropriate size.

The storing regions 610 may be divided into a plurality of levels. For example, the storing regions 610 may be divided into a first level 620 and a second level 630. The first level 620 may include a plurality of ranges 621 to 624. The ranges 621 to 624 may include m ranges. Each of the ranges 621 to 624 may include at least two or more storing regions. For example, a range 0 621 may include four storing regions REGION 0 to REGION 3 of the storing regions 610. A range 1 622 may include four storing regions REGION 4 to REGION 7 of the storing regions 610. A range 2 623 may include four storing regions REGION 8 to REGION 11 of the storing regions 610. A range (m−1) 624 may include four storing regions REGION (n−4) to REGION (n−1) of the storing regions 610.

The second level 630 may include storing regions 631 to 634 that respectively correspond to the ranges 621 to 624. Each of the storing regions 631 to 634 may include four storing regions REGION 0 to REGION 3.

The storing regions 610 are divided into a plurality of levels as described above in order to quickly search the cache 522. That is, according to the embodiment of the present disclosure, instead of searching the cache 522 on the basis of a storing region such as, an address, the cache search operation is performed on the basis of a range, which has a greater size than a storing region, in the first stage, and then the cache search operation is performed on the basis of a storing region in the second stage. Although FIG. 6 shows an example in which the storing regions included in the cache 522 are hierarchically divided into two levels, the spirit and concept of the present disclosure may be applied similarly to other cases in which the storing regions are hierarchically divided into a plurality of levels that are determined by an appropriate size.

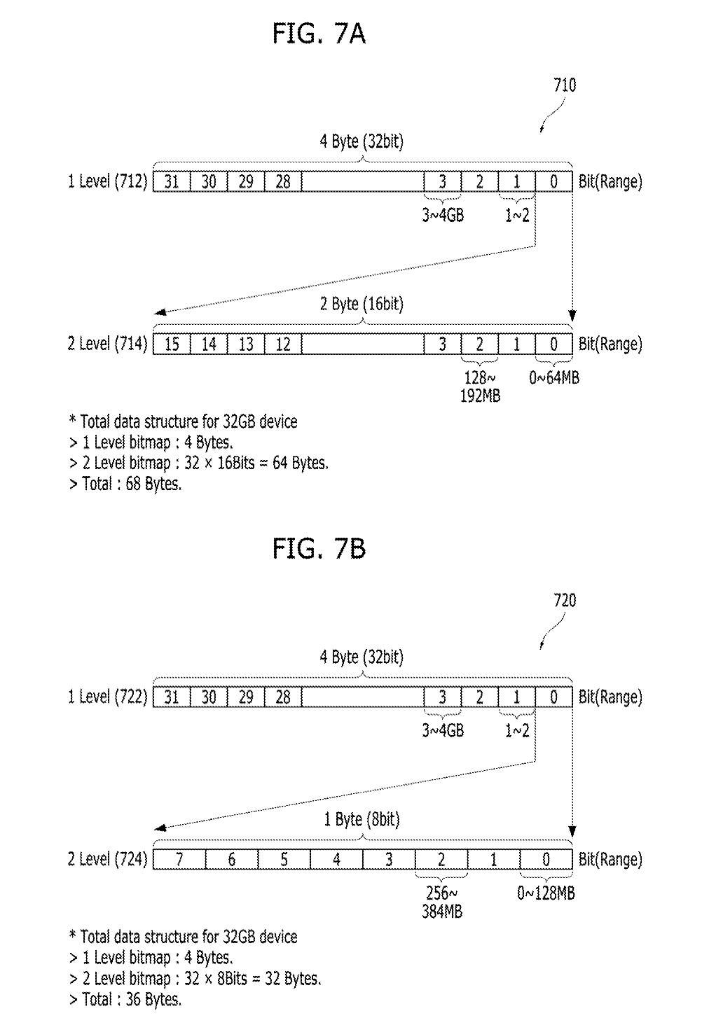

FIG. 7A illustrates an example of a bitmap structure for cache search in accordance with an embodiment of the present disclosure. Although FIG. 7A shows a bitmap structure that is hierarchically layered in two levels since the cache 522 shown in FIG. 5 is a 32-GB device and the cache 522 is layered in two levels, the embodiments of the present disclosure are not limited to two levels.

Referring to FIG. 7A, a bitmap 710 may include a 1-level bitmap 712 and a 2-level bitmap 714. The 1-level bitmap 712 may include 32 bits including a bit 0 to a bit 31. In short, the 1-level bitmap 712 may use a 4-byte or 32 bit variable. Each bit of the 1-level bitmap 712 may correspond to a range for example, 1 GB, including a predetermined number of regions among the storing regions that are included in the cache 522. A bit 0 may correspond to a range between 0 and 1 GB. A bit 1 may correspond to a range between 1 and 2 GB. A bit 2 may correspond to a range between 2 and 3 GB. A bit 3 may correspond to a range between 3 and 4 GB. When a data is stored in a corresponding range, the value of the bit for the corresponding range may be set to ‘1’.

The 2-level bitmap 714 may exist as a lower level than the 1-level bitmap 712. For example, the 2-level bitmap 714 may include 16 bits from a bit 0 to a bit 15. In short, the 2-level bitmap 714 may use a 2-byte or 16 bit variable.

When the 2-level bitmap 714 is 16 bits, each bit of the 2-level bitmap 714 may correspond to a predetermined region for example, 64 MB. A bit 0 may correspond to a region between 0 and 64 MB. A bit 1 may correspond to a region between 64 and 128 MB. A bit 2 may correspond to a region between 128 and 192 MB. A bit 3 may correspond to a region between 192 and 256 MB. When a data is stored in a corresponding region, the value of the bit for the corresponding region may be set to ‘1’.

As described above, when a 32-GB SRAM is used as the cache 522 and 32 bits are used as the 1-level bitmap 712 and 16 bits are used as the 2-level bitmap 714, the SRAM may be as large as 68 bytes (=4 bytes (or 32 bits)+{64 bytes (or 32×16 bits)}) and may be used for a cache search operation.

FIG. 7B illustrates another example of a bitmap structure for cache search in accordance with an embodiment of the present disclosure. Although FIG. 7B shows a bitmap structure that is hierarchically layered in two levels as the cache 522 shown in FIG. 5 is a 32-GB device and the cache 522 is layered in two levels, the embodiments of the present invention are not limited to two levels.

Referring to FIG. 7B, a bitmap 720 may include a 1-level bitmap 722 and a 2-level bitmap 724. The 1-level bitmap 722 may include 32 bits including a bit 0 to a bit 31. In short, the 1-level bitmap 722 may use a 4-byte or 32 bits variable. Each bit of the 1-level bitmap 722 may correspond to a range for example, 1 GB including a predetermined number of regions among the storing regions that are included in the cache 522. A bit 0 may correspond to a range between 0 and 1 GB. A bit 1 may correspond to a range between 1 and 2 GB. A bit 2 may correspond to a range between 2 and 3 GB. A bit 3 may correspond to a range between 3 and 4 GB. When a data is stored in a corresponding range, the value of the bit for the corresponding range may be set to ‘1’.

The 2-level bitmap 724 may exist as a lower level than the 1-level bitmap 722. For example, the 2-level bitmap 724 may include 8 bits from a bit 0 to a bit 8. In short, the 2-level bitmap 724 may use a 1-byte or 8 bit variable.

When the 2-level bitmap 724 is 8 bits, each bit of the 2-level bitmap 724 may correspond to a predetermined region for example, 128 MB. A bit 0 may correspond to a region between 0 and 128 MB. A bit 1 may correspond to a region between 128 and 256 MB. A bit 2 may correspond to a region between 256 and 384 MB. A bit 3 may correspond to a region between 384 and 512 MB. When a data is stored in a corresponding region, the value of the bit for the corresponding region may be set to ‘1’.

As described above, when a 32-GB SRAM is used as the cache 522 and 32 bits are used as the 1-level bitmap 722 and 8 bits are used as the 2-level bitmap 724, the SRAM as large as 36 bytes (=4 bytes (or 32 bits)+{32 bytes (or 32×8 bits)}) may be used for a cache search operation.

According to the embodiments of the present disclosure, the controller 520 in the memory system 510 may represent the cache 522 in a multi-level bitmap for example, a two-level bitmap, and search the cache 522 by using the bitmap on the basis of a range which corresponds to a predetermined region. The controller 520 may be able to reduce the search time for the cache 522 by decreasing the size of the data structure which is used for searching the cache 522. Also, as the amount of data cache is varied, the search time for the cache 522 may be varied and the phenomenon that the read latency becomes irregular may be removed as well.

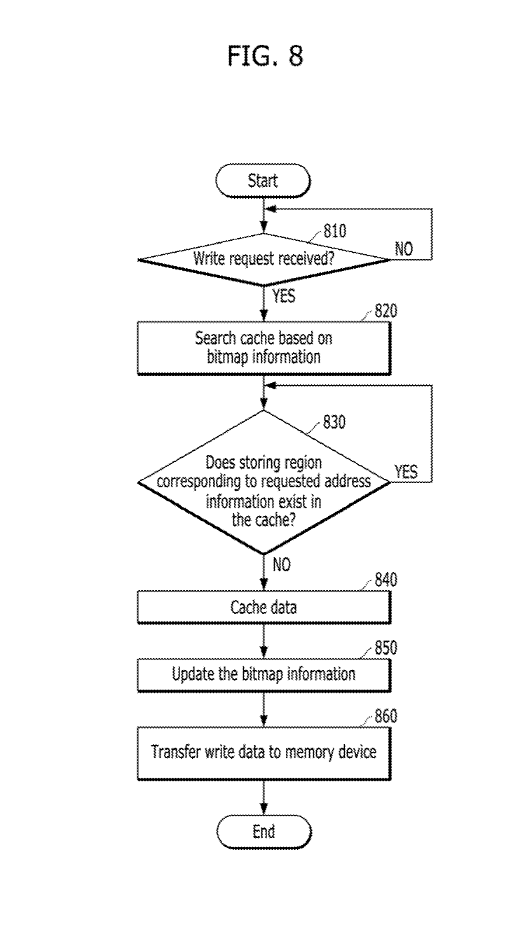

FIG. 8 is a flowchart illustrating an operation of a controller in accordance with an embodiment of the present disclosure. FIG. 8 shows a write operation which is performed on the memory device 530 by the controller 520 or the processor 524 illustrated in FIG. 5.

Referring to FIG. 8, at operation 810, the controller 520 may decide whether or not a write request is received from the host 50.

When it is determined that a write request is received from the host 50, at operation 820, the controller 520 may search the cache 522 based on hierarchical bitmap information. At operation 830, the controller 520 may determine whether or not there is a storing region corresponding to address information for example, a LBA which is included in the write request for the cache 522.

According to various embodiments of the present disclosure, as illustrated in FIG. 6, when the storing regions included in the cache 522 are divided into a plurality of ranges each of which includes at least two storing regions, the hierarchical bitmap information may hierarchically represent a plurality of ranges and a plurality of storing regions. When the hierarchical bitmap includes a two-level bitmap as illustrated in FIG. 7A or 7B, the 1-level bits may respectively correspond to the ranges, and the 2-level bits may respectively correspond to the storing regions that are included in each of the ranges.

When it is determined that the storing region corresponding to the address information which is included in the write request does not exist in the cache 522, at operation 840, the controller 520 may cache the data that is received along with the write request in the cache 522. Subsequently, at operation 850, the controller 520 may update the bitmap information by setting the bit value for example, ‘1’, which represents the storing region and the range that are related to the caching of the write data.

Subsequently, at operation 860, the controller 520 may transfer the data that is cached in the cache 522 to the memory device 530. For example, the controller 520 may transfer the data that is cached in the cache 522 to the memory device 530 through a cache copy or a cache flush. The memory device 530 may then store the received write data in the storing region for example, PBA corresponding to the address information for example, LBA which is included in the write request.

When the data is flushed from the cache 522 to the memory device 530, the controller 520 may update the bitmap information by clearing the corresponding bit value of the bitmap information.

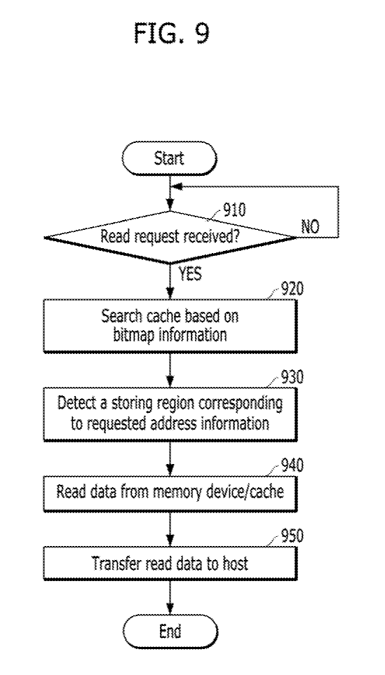

FIG. 9 is a flowchart illustrating an operation of a controller in accordance with an embodiment of the present disclosure. The operation flow of FIG. 9 may correspond to the read operation for the memory device 530 which is performed by the controller 520 or the processor 524 in FIG. 5.

Referring to FIG. 9, at operation 910, the controller 520 may determine whether or not a read request is received from the host 50.

When it is determined that a read request is received from the host 50, the controller 520 may search the cache 522 based on hierarchical bitmap information at operation 920 and determine whether or not a storing region corresponding to address information for example, LBA which is included in the read request exists in the cache 522 at operation 930.

According to various embodiments of the present disclosure, as illustrated in FIG. 6, when the storing regions included in the cache 522 are divided into a plurality of ranges each of which includes at least two storing regions, the hierarchical bitmap information may hierarchically represent a plurality of ranges and a plurality of storing regions. When the hierarchical bitmap includes two-level bitmap as illustrated in FIG. 7A or 7B, the 1-level bits may respectively correspond to the ranges, and the 2-level bits may respectively correspond to the storing regions that are included in each of the ranges.

At operation 940, the controller 520 may perform a data read operation based on the decision result on whether there is a storing region corresponding to address information for example, LBA which is included in the read request in the cache 522.

When it is determined that there is a storing region corresponding to the address information for example, LBA which is included in the read request in the cache 522, the controller 520 may read a data which is stored in the corresponding region of the cache 522. Otherwise, when it is determined that there is not a storing region corresponding to the address information which is included in the read request in the cache 522, the controller 520 may read the data stored in the corresponding region of the memory device 530, which is the storing region for example, PBA corresponding to the address information for example, LBA included in the read request, and store the read data in the cache 522.

At operation 950, the controller 520 may transfer the read data that is read from the cache 522 or the memory device 530 to the host 50.

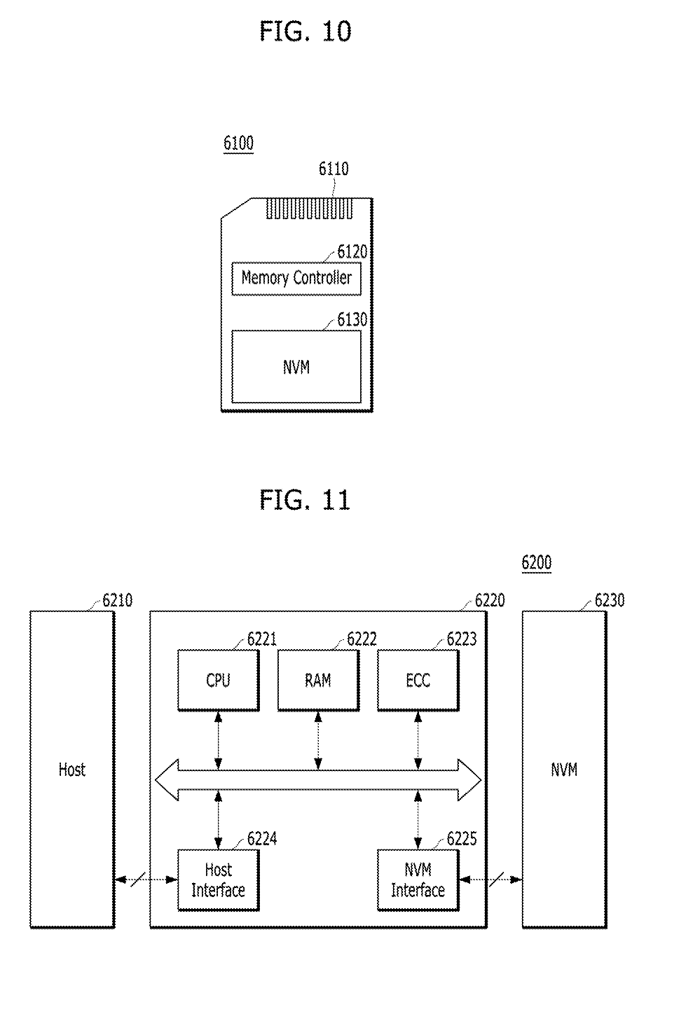

Hereinafter, a data processing system and electronic equipment provided with the memory system 110 including the memory device 150 and the controller 130 described with reference to FIGS. 1 to 9 in accordance with an embodiment will be described in more detail with reference to FIGS. 10 to 18.

FIGS. 10 to 18 are diagrams schematically illustrating application examples of the data processing system of FIG. 1 in accordance with various embodiments of the present disclosure.

FIG. 10 is a diagram schematically illustrating another example of the data processing system including the memory system in accordance with an embodiment of the present disclosure. FIG. 10 schematically illustrates a memory card system to which the memory system in accordance with an embodiment is applied.

Referring to FIG. 10, the memory card system 6100 may include a connector 6110, a memory controller 6120, and a memory device 6130.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a random access memory (RAM), a processing unit, a host interface, a memory interface and an error correction unit. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (WI-FI) and Bluetooth. Thus, the memory system and the data processing system in accordance with an embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may construct a solid state drive (SSD) by being integrated into a single semiconductor device. Also, the memory controller 6120 and the memory device 6130 may construct a memory card such as a PC card for example, Personal Computer Memory Card International Association (PCMCIA), a compact flash (CF) card, a smart media card (e.g., SM and SMC), a memory stick, a multimedia card (e.g., MMC, RS-MMC, MMCmicro and eMMC), an SD card for example, SD, miniSD, microSD and SDHC, and a universal flash storage (UFS).

FIG. 11 is a diagram schematically illustrating another example of the data processing system including the memory system in accordance with an embodiment of the present disclosure.

Referring to FIG. 11, the data processing system 6200 may include a memory device 6230 having one or more nonvolatile memories (NVMs) and a memory controller 6220 for controlling the memory device 6230. The data processing system 6200 illustrated in FIG. 11 may serve as a storage medium such as a memory card for example, CF, SD, micro-SD or the like, or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation for the memory device 6230 in response to a request from the host 6210, and the memory controller 6220 may include a central processing unit (CPU) 6221, a random access memory (RAM) as a buffer memory 6222, an error correction code (ECC) circuit 6223, a host interface 6224 and an NVM interface as a memory interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an error correction code for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using any suitable method including a coded modulation such as a low density parity check (LDPC) code, a Bose-Chaudhuri-Hocquenghem (BCH) code, a turbo code, Reed-Solomon (RS) code, a convolution code, a recursive systematic code (RSC), a trellis-coded modulation (TCM) or a Block coded modulation (BCM).

The memory controller 6220 may transmit/receive data to/from the host 6210 through the host interface 6224, and transmit/receive data to/from the memory device 6230 through the NVM interface 6225. The host interface 6224 may be connected to the host 6210 through at least one of various interface protocols such as a parallel advanced technology attachment (PATA) bus, a serial advanced technology attachment (SATA) bus, a small computer system interface (SCSI), a universal serial bus (USB), a peripheral component interconnection express (PCIe) or a NAND interface. The memory controller 6220 may have a wireless communication function with a mobile communication protocol such as wireless fidelity (WI-FI) or long term evolution (LTE). The memory controller 6220 may be connected to an external device, for example, the host 6210 or another external device, and then transmit/receive data to/from the external device. In particular, as the memory controller 6220 is configured to communicate with the external device through one or more various communication protocols, the memory system and the data processing system in accordance with an embodiment may be applied to wired/wireless electronic devices or particularly a mobile electronic device.

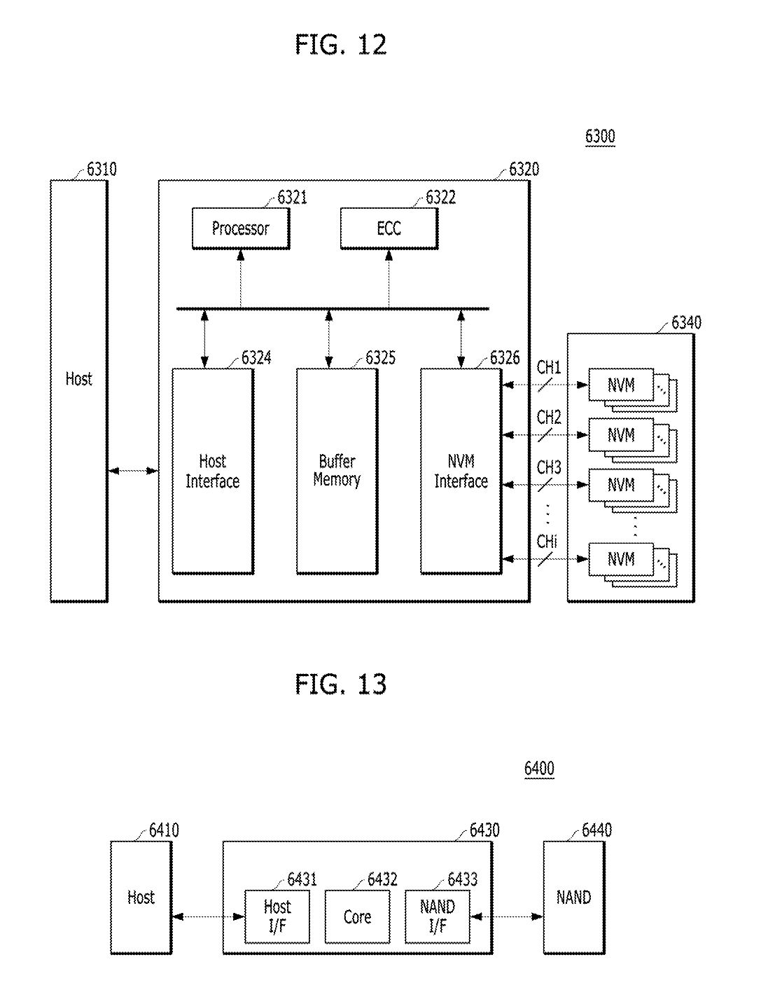

FIG. 12 is a diagram schematically illustrating another example of the data processing system including the memory system in accordance with an embodiment of the present disclosure. FIG. 12 schematically illustrates a solid state drive (SSD) 6300 to which the memory system in accordance with an embodiment is applied.

Referring to FIG. 12, the SSD 6300 may include a controller 6320 and a memory device 6340 including a plurality of nonvolatile memories. The controller 6320 may correspond to the controller 130 in the memory system 110 of FIGS. 1 and 5, and the memory device 6340 may correspond to the memory device 150 in the memory system of FIG. 1.

More specifically, the controller 6320 may be connected to the memory device 6340 through a plurality of channels CH1 to CHi. The controller 6320 may include a processor 6321, a buffer memory 6325, an error correction code (ECC) circuit 6322, a host interface 6324 and a nonvolatile memory interface as a memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as a dynamic random access memory (DRAM), a synchronous dynamic random access memory (SDRAM), a double data rate (DDR) SDRAM, a low power double data rate (LPDDR) SDRAM and graphic random access memory (GRAM) or nonvolatile memories such as a ferroelectric random access memory (FRAM), a resistive random access memory (ReRAM), a spin-transfer torque magnetic random access memory (STT-MRAM) and a phase change random access memory (PRAM). For convenience of description, FIG. 12 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 13 is a diagram schematically illustrating another example of the data processing system including the memory system in accordance with an embodiment of the present disclosure. FIG. 13 schematically illustrates an embedded Multi-Media Card (eMMC) to which the memory system in accordance with an embodiment is applied.

Referring to FIG. 13, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface such as an MMC interface as described with reference to FIG. 1. Furthermore, the host interface 6431 may serve as a serial interface such as an ultra-high speed class 1 (UHS-I)/UHS class 2 (UHS-II) and a universal flash storage (UFS) interface.

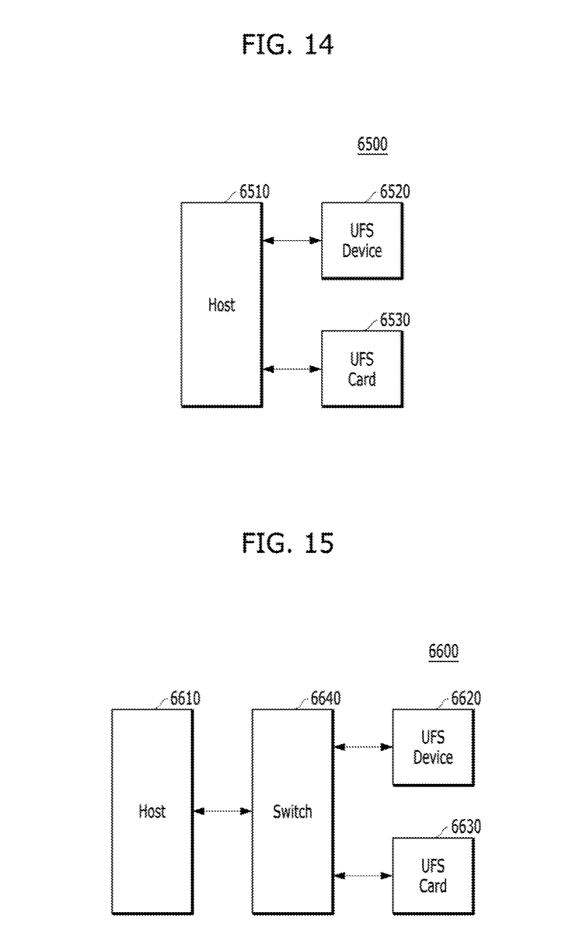

FIGS. 14 to 17 are diagrams schematically illustrating other examples of the data processing system including the memory system in accordance with embodiments of the present disclosure. FIGS. 14 to 17 schematically illustrate universal flash storage (UFS) systems to which the memory system in accordance with an embodiment is applied.

Referring to FIGS. 14 to 17, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 11 to 13, and the UFS cards 6530, 6630, 6730 and 6830 may be embodied in the form of the memory card system 6100 described with reference to FIG. 10.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI Unified Protocol (UniPro) in Mobile Industry Processor Interface (MIPI). Furthermore, the UFS devices 6520, 6620, 6720 and 6820 and the UFS cards 6530, 6630, 6730 and 6830 may communicate with each other through various protocols other than the UFS protocol, for example, USB flash drives (UFDs), multimedia card (MMC), secure digital (SD), mini-SD, and micro-SD.

In the UFS system 6500 illustrated in FIG. 14, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In an embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In an embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

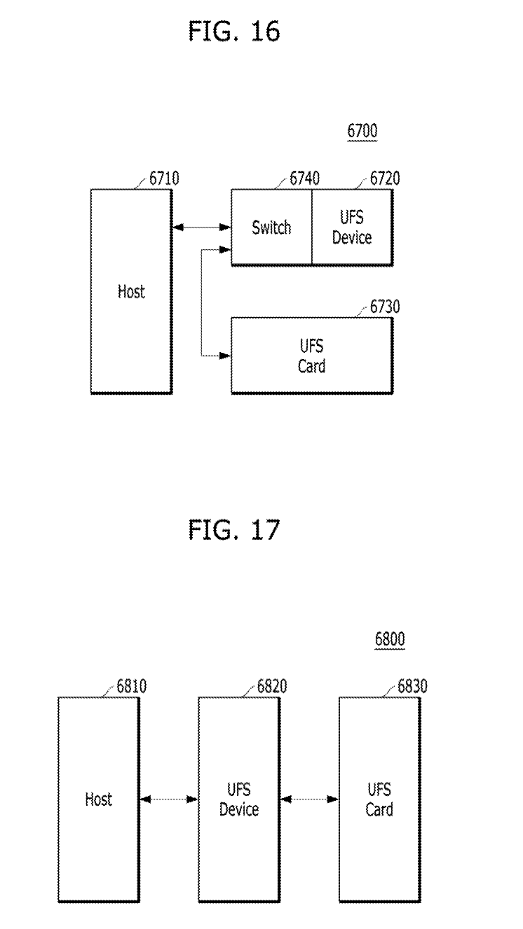

In the UFS system 6700 illustrated in FIG. 16, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 17, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target identifier (ID) switching operation. At this time, the host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

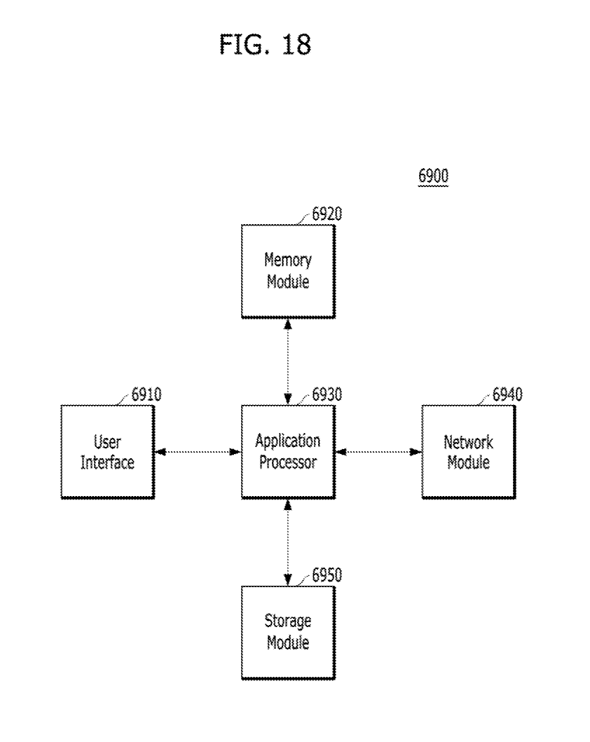

FIG. 18 is a diagram schematically illustrating another example of the data processing system including the memory system in accordance with an embodiment of the present disclosure. FIG. 18 is a diagram schematically illustrating a user system to which the memory system in accordance with an embodiment is applied.

Referring to FIG. 18, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDARM, an LPDDR2 SDRAM and an LPDDR3 SDRAM or a nonvolatile RAM such as a phase change random access memory (PRAM), a resistive random access memory (ReRAM), a magnetic random access memory (MRAM) and a ferroelectric random access memory (FRAM). For example, the application processor 6930 and the memory module 6920 may be packaged and mounted, based on a package-on-package (POP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (WI-DI), thereby communicating with wired and/or wireless electronic devices or particularly mobile electronic devices. Therefore, the memory system and the data processing system, in accordance with an embodiment of the present invention, can be applied to wired and/or wireless electronic devices. The network module 6940 may be included in the application processor 6930.

The storage module 6950 may store data, for example, data provided from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, a light emitting diode (LED), a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the processor 6930 on a display/touch module of the mobile electronic device, or support a function of receiving data from the touch panel.

While the present invention has been described with respect to the specific embodiments, it will be apparent to those skilled in the art that various other embodiments, changes and modifications thereof may be made without departing from the spirit and scope of the invention as defined in the following claims.

What is claimed is:

1. A memory system, comprising:
a memory device; and
a controller including a cache which is coupled between a host and the memory device and includes a plurality of storing regions,
suitable for determining whether or not a storing region corresponding to address information, which is requested by the host, exists in the cache among the plurality of the storing regions based on bitmap information which hierarchically represents the plurality of the storing regions.

2. The memory system of claim 1, wherein the controller divides the plurality of the storing regions into a plurality of ranges, each of the plurality of ranges including at least two storing regions, and
generates the bitmap information which hierarchically represents the plurality of the ranges and the plurality of the storing regions.

3. The memory system of claim 2, wherein the bitmap information includes 1-level bits and 2-level bits, and
the 1-level bits respectively correspond to the plurality of the ranges, and
the 2-level bits respectively correspond to storing regions that are included in each of the plurality of the ranges.

4. The memory system of claim 1, wherein the controller updates the bitmap information in response to a write request or a read request from the host.

5. The memory system of claim 4, wherein when the controller determines that a storing region corresponding to address information according to the write request does not exist in the cache, the controller caches the data in the cache and sets a value of a corresponding bit of the bitmap information based on the cached result.

6. The memory system of claim 5, wherein when the data is flushed from the cache to the memory device, the controller clears the value of the corresponding bit of the bitmap information.

7. The memory system of claim 4, wherein when the controller determines that a storing region corresponding to address information according to the read request exists in the cache, the controller reads a data according to the read request which is stored in the cache and transfers the data to the host.

8. A memory controller, comprising:
a cache coupled between a host and a memory device, including a plurality of storing regions; and
a processor suitable for determining whether or not a storing region corresponding to address information, which is requested by the host, exists in the cache among the plurality of the storing regions based on bitmap information which hierarchically represents the plurality of the storing regions.

9. The memory controller of claim 8, wherein the processor divides the plurality of the storing regions into a plurality of ranges, each of the plurality of ranges including at least two storing regions, and
generates the bitmap information which hierarchically represents the plurality of the ranges and the plurality of the storing regions.

10. The memory controller of claim 9, wherein the bitmap information includes 1-level bits and 2-level bits, and
the 1-level bits respectively correspond to the plurality of the ranges, and
the 2-level bits respectively correspond to storing regions that are included in each of the plurality of the ranges.

11. The memory controller of claim 8, wherein the processor updates the bitmap information in response to a write request or a read request from the host.

12. The memory controller of claim 11, wherein when the processor determines that a storing region corresponding to address information according to the write request does not exist in the cache, the processor caches the data in the cache and sets a value of a corresponding bit of the bitmap information based on the cached result.

13. The memory controller of claim 12, wherein when the data is flushed from the cache to the memory device, the processor clears the value of the corresponding bit of the bitmap information.

14. The memory controller of claim 11, wherein when the processor determines that a storing region corresponding to address information according to the read request exists in the cache, the processor reads a data according to the read request which is stored in the cache and transfers the data to the host.

15. A method for operating a memory controller including a cache that is coupled between a host and a memory device and includes a plurality of storing regions, comprising:
receiving a request from the host; and
determining whether or not a storing region corresponding to address information which is included in the request exists in the cache among the plurality of the storing regions based on bitmap information which hierarchically represents the plurality of the storing regions.

16. The method of claim 15, further comprising:
dividing the plurality of the storing regions into a plurality of ranges, each of the plurality of ranges including at least two storing regions; and
generating the bitmap information which hierarchically represents the plurality of the ranges and the plurality of the storing regions.

17. The method of claim 16, wherein the bitmap information includes 1-level bits and 2-level bits, and
the 1-level bits respectively correspond to the plurality of the ranges, and
the 2-level bits respectively correspond to storing regions that are included in each of the plurality of the ranges.

18. The method of claim 15, further comprising:
updating the bitmap information in response to a write request or a read request from the host.

19. The method of claim 18, wherein the updating of the bitmap information includes:
when a storing region corresponding to address information according to the write request does not exist in the cache, caching the data in the cache and setting a value of a corresponding bit of the bitmap information based on the cached result.

20. The method of claim 18, wherein the updating of the bitmap information further includes:
when a storing region corresponding to address information according to the read request exists in the cache, reading a data according to the read request which is stored in the cache and transferring the data to the host.
